(19) United States
(12) Patent Application Publication
(10) Pub. No.: US 2009/0183692 A1
(43) Pub. Date: Jul. 23, 2009

(54) POST-OPERATIVE PROTECTIVE GARMENT FOR ANIMALS

(76) Inventors: Alessandro Rossi, Milano (IT); Antonella Moro, Milano (IT)

Correspondence Address: HOFFMANN & BARON, LLP, 6900 JERICHO TURNPIKE, SYOSSET, NY, 11791, US

(21) Appl. No.: 12/354,050

(22) Filed: Jan. 15, 2009

(30) Foreign Application Priority Data
Jan. 17, 2008 (IT) 2008A 000064

(51) Int. Cl. A01K 13/00

(52) U.S. Cl. 119/850

(57) ABSTRACT

A protective garment (1) particularly suitable for being worn by quadruped animals after a surgical operation or a medication. Said protective garment (1), by wrapping the animal body trunk, avoids the animals for reaching by paws o muzzle the portion of the trunk surgically operated or medicated, thus damaging the suture or bandage.

### FIELD OF THE INVENTION

The present invention relates to a protective garment for animals, particularly for quadruped animals, to be used after surgical operations or medications at any portion of the animal trunk.

### BACKGROUND OF THE INVENTION

After a surgical operation or a medication it needs to protect the affected portion both in case it is protected by a bandage and in case there are no protections. However, the irritation sensation, caused by the wound, often causes the animal to bit or scratch by paws the body portion next to the wound, thus damaging the bandage or suture, running the risk of reopening the wound and causing infections.

The current veterinary technique provides, after a surgical operation, the application on the animal neck of a particular funnel-shaped collar, called Elizabethan collar. Said Elizabethan collar is typically constituted by a conical frustum-shaped surface inside which, through the base having smaller area, the animal head is passed. The develop of this conical frustum-shaped surface, on the basis of the animal size, is such as to fully take the muzzle in, such that the animal is prevented, while trying to relieve the irritation caused by the wound, from reaching the operated and/or bandaged portion. This protection system, however, generates, for the animal, high stress dose, which certainly is added to trauma of the operation, as well as the accident suffered, since it cannot make many of its movements, due to the bulk of the funnel-shaped collar. Moreover said Elizabethan collar, as it is designed, does really not allow the animal for being protected in case it tries to reach the zone of the wound with its paws, or even also while scraping it against some surface.

There are then known patent documents in which there are disclosed protections for post-operative bandages that however, considered on the whole, have one or more of the following disadvantages:
the protection is formed with plastic material and therefore generates irritations while contacting the animal hair,
the protection does not fully cover the animal trunk, and therefore the use is limited to the protection of determined zones of the same trunk,
the protection is constituted by a garment fully sewn and therefore it has a difficult wearability since it has necessarily to be worn on the animal.

### SUMMARY OF THE INVENTION

The protective garment for animals according to a preferred embodiment of the present invention overcomes the aforementioned disadvantages by providing a protective garment of easy wearability, formed in not elastic material, light and therefore suitable even in climatic condition typical in summer season.

### BRIEF DESCRIPTION OF THE DRAWINGS

There will be provided a detailed description of a preferred embodiment according to the present invention, with reference to the annexed drawings, wherein:

FIG. 1 is a view of a preferred embodiment of the protective garment according to the present invention, not worn on the animal body;

FIG. 2 is a view of the embodiment in FIG. 1, worn on the animal body;

FIG. 3 is a further view of the embodiment in FIG. 1, worn on the animal body.

### DETAILED DESCRIPTION OF THE PREFERRED EMBODIMENT

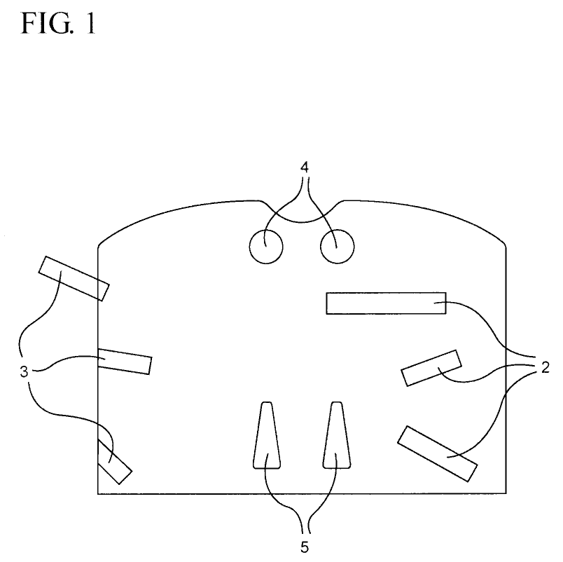

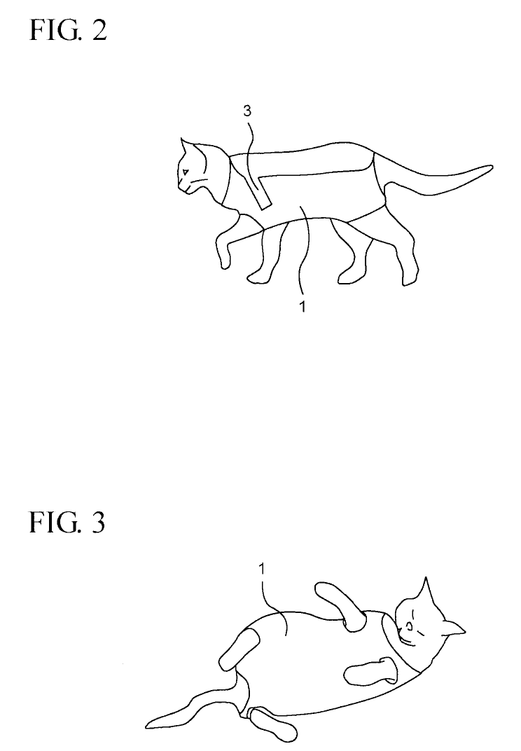

With reference to FIGS. 1 to 3, the protective garment 1 is constituted by a fabric having enough width to overlap, at the animal back, the longitudinal edges of said protective garment 1, and enough height to cover the whole animal trunk. There are, also, provided holes 4 at front paws and holes 5 at the rear paws, shaped so as to fit the body structure of the animal. The securing of the protective garment 1 on the animal body occurs by the presence of strings 3 provided on said protective garment 1, staying still onto corresponding strings 2, said strings 2 and 3 allowing a closure known on the market as VELCRO®, once the longitudinal edges of said protective garment have been overlapped on each other.

The kind of securing just described allows for obtaining an easy wearability of the protective garment 1, but, at the same time, assures a high comfort level for the animal since the garment, once secured, does not exert neither compression nor traction on the animal body. In order to avoid such actions from being exerted on the animal body, none elastic material is used as fabric of the protective garment 1. The used fabric is also treated for allowing usage thereof while directly contacting sutured wounds by stitches or clips. On the basis of the animal size, strings 3 even in elastic material and in a number ranging from 2 to 5 can be adopted.

What is claimed is:

1. A protective garment, particularly suitable for quadruped animals, constituted by a fabric having dimensions sufficient to cover the whole animal trunk, comprising:
(i) holes for inserting animal paws,
(ii) pairs of strings for securing said protective garment to the animal body.

2. The protective garment according to claim 1, wherein the number of the pairs of strings is ranging from 2 to 5.

3. The protective garment according to claim 1, wherein the material of said fabric is not elastic.

4. The protective garment according to claim 1, wherein the material of said fabric is treated for a direct contact with sutured wounds.

5. The protective garment according to claim 1, wherein the material of said strings can also be elastic.

6. The protective garment according to claim 1, wherein said strings allow for a closure known on the market as VELCRO®.
